(19) United States
(12) Patent Application Publication
(10) Pub. No.: US 2018/0229322 A1
(43) Pub. Date: Aug. 16, 2018

(54) FORCED-FEED PRESSURE CONTROL DEVICE AND FORCED-FEED PRESSURE CONTROL METHOD

(71) Applicant: DENSO TEN Limited, Kobe-shi (JP)

(72) Inventor: Hisaki HAYASHI, Kobe-shi (JP)

(73) Assignee: DENSO TEN Limited, Kobe-shi (JP)

(21) Appl. No.: 15/846,432

(22) Filed: Dec. 19, 2017

(30) Foreign Application Priority Data
Feb. 15, 2017 (JP) 2017-026331

(51) Int. Cl. B23K 3/06

(52) U.S. Cl. CPC B23K 3/0638

(57) ABSTRACT

A forced-feed pressure control device according to an embodiment includes a pressure detection nozzle, a pressure detector, and a controller. One end of the pressure detection nozzle is inserted into a casing member from which molten solder is forcibly fed to a solder jet nozzle of a jet-flow soldering device. The pressure detector is connected to another end of the pressure detection nozzle to detect a pressure of molten solder forcibly input from the one end into the pressure detection nozzle by using gas that exists between the molten solder inside the pressure detection nozzle and the pressure detector. The controller adjusts a forced-feed pressure of the molten solder to the solder jet nozzle so that the pressure of the molten solder to be detected by the pressure detector becomes a reference pressure.

### CROSS-REFERENCE TO RELATED APPLICATION

This application is based upon and claims the benefit of priority of the prior Japanese Patent Application No. 2017-026331, filed on Feb. 15, 2017, the entire contents of which are incorporated herein by reference.

### FIELD

The embodiment discussed herein is directed to a forced-feed pressure control device and a forced-feed pressure control method.

### BACKGROUND

Conventionally, there has been a jet-flow soldering device that forcibly feeds molten solder to a jet nozzle to jet the solder vertically upward from a leading end of the jet nozzle and solders an electric component to a printed circuit board, for example.

In the jet-flow soldering device, poor connection between the printed circuit board and the electric component may occur when a jet height of the molten solder jetted from the jet nozzle is lower than an ideal height, and a bridge phenomenon may occur to short-circuit between adjacent terminals when the jet height is higher than the ideal height.

Therefore, there has been a soldering device that is provide with a dummy jet nozzle separately from the jet nozzle to detect a jet height of molten solder jetted from the dummy jet nozzle by using an optical sensor and control the jet height of the molten solder to the ideal height on the basis of the detection result (see, for example, Japanese Laid-open Patent Publication No. 2000-200966).

However, when the jet height of the molten solder itself jetted from the jet nozzle is detected by a sensor and the like, solder solidified by oxidization may be attached to the jet nozzle. In this case, the jet height of the solder is unable to be detected with high accuracy. Therefore, in the conventional soldering device, the jet height of the molten solder becomes unable to be controlled to the ideal height.

### SUMMARY

A forced-feed pressure control device according to an embodiment includes a pressure detection nozzle, a pressure detector, and a controller. One end of the pressure detection nozzle is inserted into a casing member from which molten solder is forcibly fed to a solder jet nozzle of a jet-flow soldering device. The pressure detector is connected to another end of the pressure detection nozzle to detect a pressure of molten solder forcibly input from the one end into the pressure detection nozzle by using gas that exists between the molten solder inside the pressure detection nozzle and the pressure detector. The controller adjusts a forced-feed pressure of the molten solder to the solder jet nozzle so that the pressure of the molten solder to be detected by the pressure detector becomes a reference pressure.

### BRIEF DESCRIPTION OF DRAWINGS

A more complete appreciation of the present application and many of the attendant advantages thereof will be readily obtained as the same becomes better understood by reference to the following detailed description when considered in connection with the accompanying drawings, wherein:

FIG. 1 is an explanatory diagram illustrating a forced-feed pressure control device and a jet-flow soldering device according to an embodiment;

FIG. 2 is an explanatory diagram illustrating one example of an operation of the jet-flow soldering device according to the embodiment;

FIGS. 3A to 3C are explanatory diagrams illustrating a forced-feed pressure control method according to the embodiment;

FIG. 4 is a timing chart illustrating operations and transitions of states of the forced-feed pressure control device and the jet-flow soldering device according to the embodiment; and

FIG. 5 is a flowchart illustrating a process that is executed by a controller according to the embodiment.

### DESCRIPTION OF EMBODIMENT

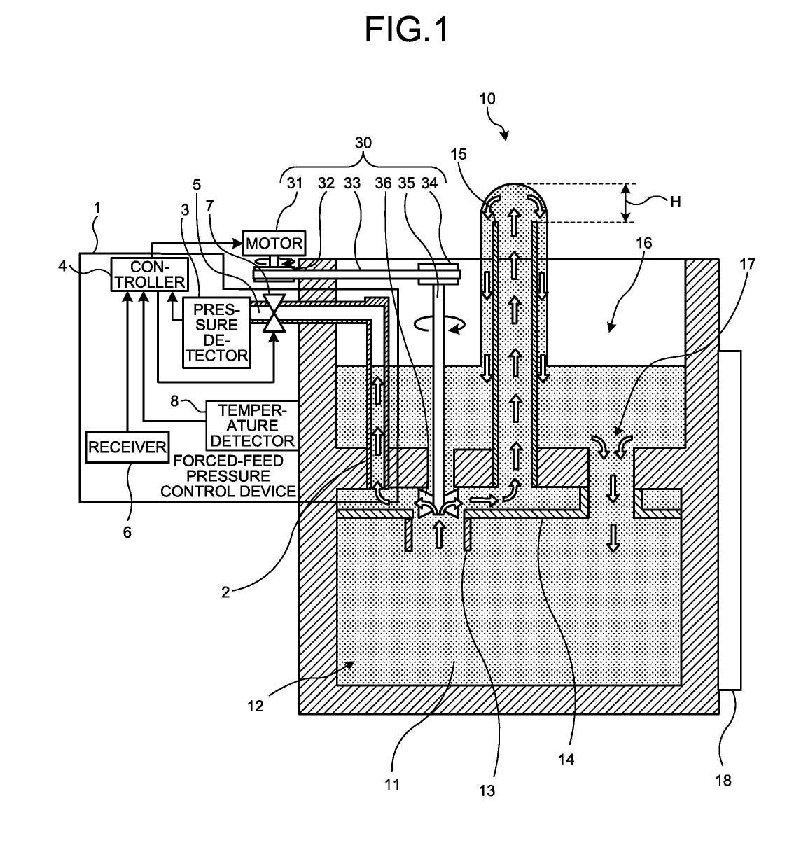

Hereinafter, an embodiment of a forced-feed pressure control device and a forced-feed pressure control method disclosed in the present application will be explained in detail with reference to the accompanying drawings. It is not intended that this invention be limited to the embodiment described below. FIG. 1 is an explanatory diagram illustrating a forced-feed pressure control device 1 and a jet-flow soldering device 10 according to an embodiment. A functional block diagram of the forced-feed pressure control device 1 and a schematic sectional diagram of the jet-flow soldering device 10 are illustrated in FIG. 1.

At first, a configuration of the jet-flow soldering device 10 to be controlled by the forced-feed pressure control device 1 is explained. As illustrated in FIG. 1, the jet-flow soldering device 10 includes a solder tank 12 that stores molten solder 11, a pump 30 that pumps up the molten solder 11 from the solder tank 12, and a jet nozzle 15 that jets the molten solder 11 pumped up by the pump 30 vertically upward.

Moreover, the jet-flow soldering device 10 includes a recovery tank 16 that recovers the molten solder 11 jetted from the jet nozzle 15. In this way, the jet-flow soldering device 10 according to the embodiment has a dual-tank structure in which the recovery tank 16 is provided on the solder tank 12.

A heater 18 is provided on side surfaces of the solder tank 12 and the recovery tank 16. The heater 18 heats and melts solder in the solder tank 12 and the recovery tank 16, and then keeps a temperature of the molten solder 11 at a temperature (hereinafter, simply referred to as “suitable temperature”) suitable for soldering.

The solder tank 12 includes, on its upper side, a solder suction nozzle 13 that sucks up the molten solder 11 upward and a casing member 14 that forcibly feeds the molten solder 11 sucked up by the solder suction nozzle 13.

The pump 30 includes a motor 31, a drive sprocket 32, a chain 33, a driven sprocket 34, a rotation shaft 35, and an impeller 36. The pump 30 rotates the drive sprocket 32 by using the motor 31, transmits a rotating force of the drive sprocket 32 to the driven sprocket 34 via the chain 33, and drives the rotation shaft 35 connected to the driven sprocket 34 to rotate the impeller 36.

The pump 30 sucks up the molten solder 11 in the solder tank 12 from the solder suction nozzle 13 to the casing member 14 by using a rotating force of the impeller 36 as illustrated by void arrows of FIG. 1, and forcibly feeds the sucked molten solder 11 from the casing member 14 to the jet nozzle 15.

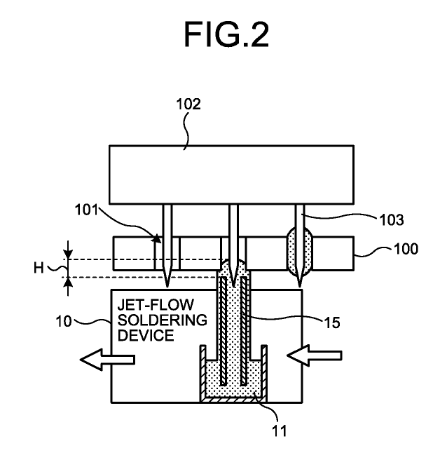

Thereby, the molten solder 11 is jetted vertically upward from an upper end of the jet nozzle. The jet-flow soldering device 10 perform soldering by attaching a part of the molten solder 11 jetted from the upper end of the jet nozzle 15 to, for example, connection points of a printed circuit board. One example of a working process of the jet-flow soldering device 10 will be described with reference to FIG. 2.

The remaining molten solder 11 not attached to the print circuit board is recovered into the recovery tank 16 through side surfaces of the jet nozzle 15, flows into the solder tank 12 from a recovery hole 17 provided on a bottom surface of the recovery tank 16 to communicate with the solder tank 12, and again is stored in the solder tank 12.

In this manner, the jet-flow soldering device 10 performs soldering while circulating the molten solder 11 through the route of the solder tank 12, the solder suction nozzle 13, the casing member 14, the jet nozzle 15, the recovery tank 16, the recovery hole 17, and the solder tank 12.

The forced-feed pressure control device 1 according to the embodiment adjusts a distance (hereinafter, referred to as “jet height H”) from the upper end of the jet nozzle 15 of the jet-flow soldering device 10 to the maximum arrival point of the jetted molten solder 11 to an ideal height suitable for soldering.

The forced-feed pressure control device 1 includes a pressure detection nozzle 2, a pressure detector 3, and a controller 4. One end of the pressure detection nozzle 2 is inserted into the casing member 14 from which the molten solder 11 is forcibly fed to the jet nozzle 15 of the jet-flow soldering device 10.

The pressure detector 3 is connected to the other side of the pressure detection nozzle 2, and detects a pressure of the molten solder 11 forcibly fed from the casing member 14 to an inner part of the pressure detection nozzle 2 by using gas (herein, assumed as “air 5”) that exists between the molten solder 11 in the pressure detection nozzle 2 and the pressure detector 3.

The controller 4 includes a microcomputer and various types of circuits having a central processing unit (CPU), a read only memory (ROM), a random access memory (RAM), an input-output port, and the like, for example. A part or the whole of the processing units included in the controller 4 may be configured by hardware such as an application specific integrated circuit (ASIC) and a field programmable gate array (FPGA).

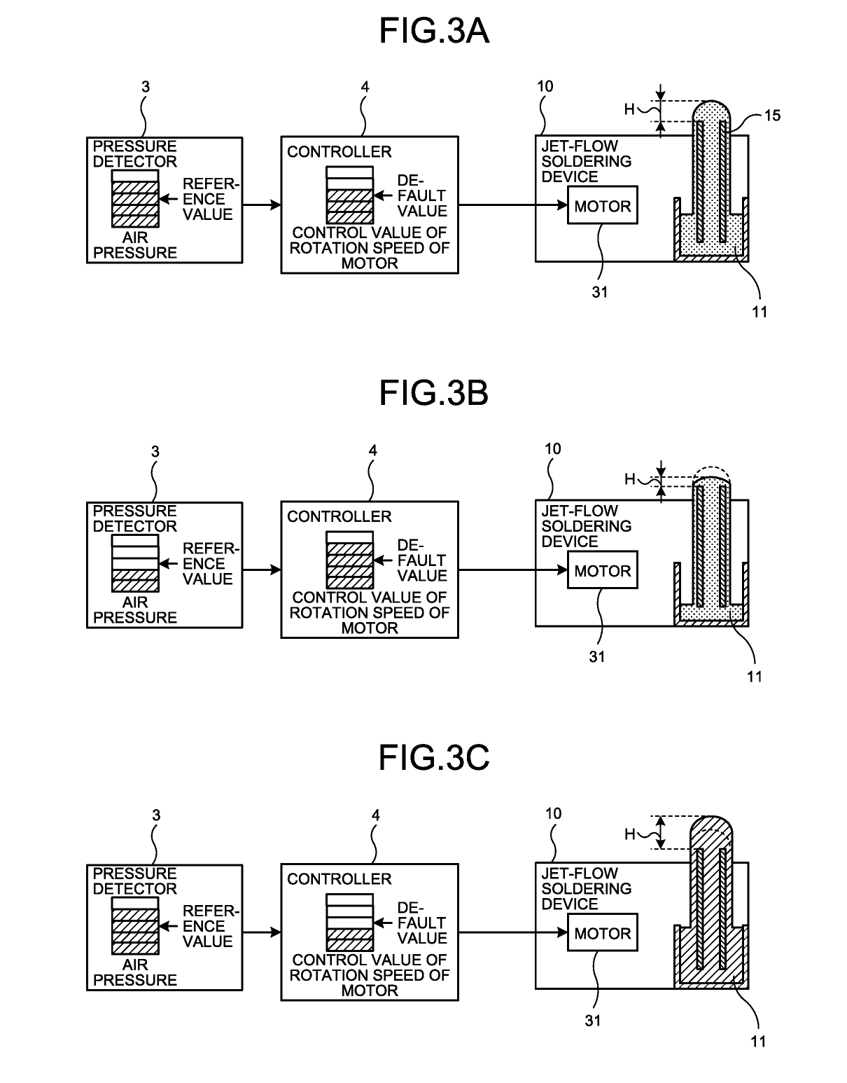

The controller 4 adjusts a forced-feed pressure of the molten solder 11 to be fed to the jet nozzle 15 by controlling a drive signal to be output to the motor 31 so that the pressure of the molten solder 11 detected by the pressure detector 3 becomes a reference pressure. One example of operation control of the motor 31 by the controller 4 will explained with reference to FIGS. 3A to 3C.

In this manner, the forced-feed pressure control device 1 detects the forced-feed pressure of the molten solder 11 by using the pressure of the air 5 in the pressure detection nozzle 2 compressed by the forced feed of the molten solder 11, without using the jet height of the molten solder 11 itself jetted from the jet nozzle 15 or a dummy jet nozzle.

Therefore, the forced-feed pressure control device 1 accurately detects the forced-feed pressure of the molten solder 11 even when solder solidified by oxidization is attached to the leading end of the jet nozzle 15 or the dummy jet nozzle, for example. Thus, the forced-feed pressure control device 1 can control the jet height H of the molten solder 11 to the ideal height.

For example, when the pressure of the molten solder forcibly fed in the casing member 14 is directly detected, an expensive pressure sensor having heat resistance is required because the temperature of the molten solder 11 becomes about 300 degrees Celsius.

Contrariwise, because the forced-feed pressure control device 1 detects the forced-feed pressure of the molten solder 11 from the pressure of the air 5 in the pressure detection nozzle 2, the forced-feed pressure control device 1 can be manufactured at a low cost by adopting a cheap pressure detector not having heat resistance as the pressure detector 3.

The forced-feed pressure control device 1 further includes a receiver 6 that receives the jet height H of the molten solder 11 to be jetted from the jet nozzle 15. The controller 4 sets the forced-feed pressure, by which the jet height H of the molten solder 11 from the jet nozzle 15 becomes the height received by the receiver 6, as the reference pressure.

Thereby, the forced-feed pressure control device 1 can achieve an ideal jet height H by a user inputting a desired jet height from the receiver 6 when ideal jet heights H of the molten solder 11 are different depending on shapes of electronic components to be soldered.

Moreover, the forced-feed pressure control device 1 includes an on-off valve 7 that opens and closes an exhaust hole that evacuates the air 5 in the pressure detection nozzle 2, and a temperature detector 8 that detects the temperature of the molten solder 11. The controller 4 keeps the on-off valve 7 in an opened state until the temperature detected by the temperature detector 8 reaches a predetermined temperature (hereinafter, referred to as “suitable temperature”) suitable for soldering. Thereafter, the controller 4 changes the state of the on-off valve 7 to a closed state when the temperature of the molten solder 11 reaches the suitable temperature, and then starts to adjust a forced-feed pressure.

Thereby, the forced-feed pressure control device 1 can prevent the pressure change of the air 5 rising independently of the forced-feed pressure of the molten solder 11 from being detected erroneously as the change of the forced-feed pressure during a time period in which the jet-flow soldering device 10 heats the molten solder 11 up to the suitable temperature before stating operations.

Next, one example of an operation of the jet-flow soldering device 10 will explained with reference to FIG. 2. FIG. 2 is an explanatory diagram illustrating one example of an operation of the jet-flow soldering device 10 according to the embodiment. As illustrated in FIG. 2, the jet-flow soldering device 10 performs operations of soldering a printed circuit board 100 arranged above the jet nozzle 15 and an electric component 102 arranged above the printed circuit board 100, for example.

The printed circuit board 100 includes a plurality of connection holes 101 that pass through both sides of the printed circuit board 100. Inner peripheral surfaces of the connection holes 101 are coated by metallic films. The metallic films that coat the inner peripheral surfaces of the connection holes 101 are connected to predetermined printed wiring provided in the printed circuit board 100.

The electric component 102 includes metallic leads 103 to be connection terminals at positions corresponding to the respective connection holes 101 of the printed circuit board 100. The electric component 102 is arranged above the jet-flow soldering device 10 in a state where the leads 103 are inserted into the respective connection holes 101 of the printed circuit board 100.

The jet-flow soldering device 10 is connected to an unillustrated robot, and moves in a void-arrow direction in accordance with a moving operation of the robot to perform soldering operations while jetting the molten solder 11 from the jet nozzle 15.

Specifically, the jet-flow soldering device 10 moves in a horizontal direction (freely in length and breadth directions) below the printed circuit board 100 at a height position where the jetted molten solder 11 does not make contact with the printed circuit board 100, and temporarily stops at a position where the jet nozzle 15 is below the lead 103.

Thereafter, the jet-flow soldering device 10 moves up in accordance with the operation of the robot and brings the jetted molten solder 11 into contact with the connection hole 101 of the printed circuit board 100. Thereby, the molten solder 11 is sucked up into the connection hole 101 due to a capillary phenomenon, and the lead 103 and the metallic film of the inner surface of the connection hole 101 are connected by the molten solder 11.

Thereafter, the jet-flow soldering device 10 descends up to a position where the jetted molten solder 11 does not make contact with the printed circuit board 100, and moves to a next soldering position, and then repeats the above soldering operation.

At this time, the jet-flow soldering device 10 may cause poor connection between the lead 103 and the metallic film of the inner surface of the connection hole 101, when the jet height H of the molten solder 11 is lower than the ideal value. Moreover, the jet-flow soldering device 10 may cause a short circuit between adjacent leads.

Such the change of the jet height H of the molten solder 11 occurs when an amount of the molten solder 11 stored in the jet-flow soldering device 10 is changed. Therefore, the forced-feed pressure control device 1 controls a rotation speed of the motor 31 so that the jet height H of the molten solder 11 is kept at the ideal value even when the amount of the molten solder 11 stored in the jet-flow soldering device 10 is changed. Next, the motor control will be explained with reference to FIGS. 3A to 3C. FIGS. 3A to 3C are explanatory diagrams illustrating a forced-feed pressure control method according to the embodiment.

FIGS. 3A to 3C illustrate a state where the number of rectangles with hatching in the pressure detector 3 is larger, air pressure detected by the pressure detector 3 is higher. Moreover, FIGS. 3A to 3C illustrate a state where the number of rectangles with hatching in the controller 4 is larger, the controller 4 outputs to the motor 31 a control signal for rotating the motor 31 at higher rotation speed.

As shown FIG. 3A, the jet-flow soldering device 10 stores a predetermined amount of the molten solder 11 at time point of starting the soldering operation. When the jet-flow soldering device 10 starts the soldering operation, the controller 4 outputs to the motor 31 a control signal for setting a rotation speed of the motor 31 to a default value.

Herein, the default value is a value of the rotation speed of the motor 31 such that the jet height H of the molten solder 11 becomes the ideal value when a storage amount of the molten solder 11 is in an initial state. At this time, the pressure detector 3 detects reference air pressure that is detected when the jet height H of the molten solder 11 is the ideal value, and outputs a detection result of the air pressure to the controller 4.

The controller 4 continues to output to the motor 31 the control signal for setting the rotation speed of the motor 31 to the default value during a duration time of the state illustrated in FIG. 3A. Thereby, the controller 4 can keep the jet height H of the molten solder 11 at the ideal height.

Thereafter, as illustrated in FIG. 3, the storage amount of the molten solder 11 reduces when the jet-flow soldering device 10 continues the soldering operation. Thereby, the weight of the molten solder 11 loaded onto the impeller 36 (see FIG. 1) reduces, and thus the forced-feed pressure of the molten solder 11 reduces when the rotation speed of the motor 31 is controlled at a fixed value.

Therefore, when the rotation speed of the motor 31 is kept without modification as the default value, the jet height H of the molten solder 11 becomes lower than an ideal height in a state illustrated with a dashed line of FIG. 3B. At this time, the air pressure detected by the pressure detector 3 decreases in accordance with the decrease of the forced-feed pressure of the molten solder 11.

Therefore, the controller 4 outputs to the motor 31 a control signal that increases the rotation speed of the motor 31 to be higher than the default value in accordance with the air pressure when the detection result of the air pressure lower than the reference value is input from the pressure detector 3. Thereby, the controller 4 can keep the jet height H of the molten solder 11 at the ideal height (state illustrated with dashed line in FIG. 3B).

Thereafter, as illustrated in FIG. 3C, the molten solder 11 is refilled into the jet-flow soldering device 10, and thus the storage amount of the molten solder 11 may be more than that in the initial state, for example. Thereby, because the weight of the molten solder 11 loaded onto the impeller 36 (see FIG. 1) increases greatly, the forced-feed pressure of the molten solder 11 increases when the rotation speed of the motor 31 is controlled at a fixed value.

Therefore, when the rotation speed of the motor 31 is fixed to be higher than the default value, the jet height H of the molten solder 11 is higher than the ideal height in the state illustrated with a dashed line of FIG. 3C. At this time, the air pressure detected by the pressure detector 3 increases in accordance with the increase of the forced-feed pressure of the molten solder 11.

Thus, the controller 4 outputs to the motor 31 a control signal that decreases the rotation speed of the motor 31 to be lower than the default value in accordance with the air pressure when the detection result of the air pressure higher than the reference value is input from the pressure detector 3. Thereby, the controller 4 keeps the jet height H of the molten solder 11 at the ideal height (state illustrated with dashed line in FIG. 3C).

In this manner, the forced-feed pressure control device 1 can control a control signal to be output to the motor 31 to keep the jet height H of the molten solder 11 at the ideal height on the basis of the air pressure in the pressure detection nozzle 2, and thus can be widely applied to the existing jet-flow soldering device 10.

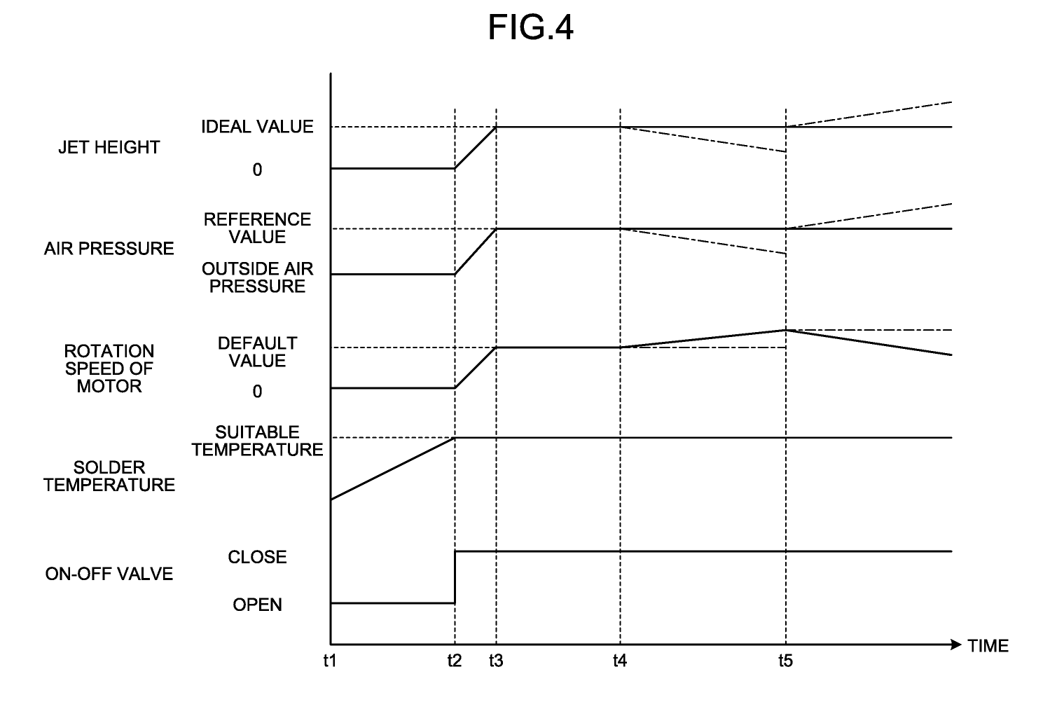

Next, a series of operations and transitions of states of the forced-feed pressure control device 1 and the jet-flow soldering device 10 described above will be explained in chronological order with reference to FIG. 4. FIG. 4 is a timing chart illustrating operations and transitions of states of the forced-feed pressure control device 1 and the jet-flow soldering device 10 according to the embodiment.

FIG. 4 illustrates, from the top, a state of the jet height of the molten solder 11, a state of the air pressure (hereinafter, simply referred to as “air pressure”) in the pressure detection nozzle 2, a state of the rotation speed of the motor 31, a state of a solder temperature, and opened and closed states of the on-off valve 7.

As illustrated in FIG. 4, the controller 4 keeps the on-off valve 7 in the opened state during a time period from a time point t1 to a time point t2 at which the solder temperature reaches the suitable temperature when the heating of the solder is started at the time point t1 before the soldering operation performed by the jet-flow soldering device 10 is started. Thereby, the air pressure is kept at a pressure equal to an outside air pressure even when the solder temperature rises. In this time period, the rotation speed of the motor 31 is zero. Therefore, the jet height H of the molten solder 11 is zero.

Thereafter, when the solder temperature reaches the suitable temperature at the time point t2, the controller 4 closes the on-off valve 7 to be in the closed state. Then, the controller 4 outputs to the motor 31 a control signal that rotates the motor 31 at an initial value. Thereby, the rotation speed of the motor 31 is gradually raised. Along with the rise, the molten solder 11 starts to be forcibly fed from the casing member 14 to the jet nozzle 15, the air pressure starts to be gradually raised, and the jet height H of the molten solder 11 starts to be gradually raised.

Thereafter, the jet-flow soldering device 10 starts to perform the soldering operation from a time point at which the rotation speed of the motor 31 reaches the default value, the air pressure reaches the reference value, and the jet height H of the molten solder 11 reaches the ideal height at time point t3.

Thereafter, when the storage amount of the molten solder 11 is decreased, the jet height H of the molten solder 11 is gradually decreased, for example, from a time point t4 as illustrated with a dashed line of FIG. 4 in a state where the jet-flow soldering device 10 keeps the rotation speed of the motor 31 constant as illustrated with a dashed line of FIG. 4. At this time, the air pressure gradually decreases in accordance with the decrease of the jet height H of the molten solder 11.

Therefore, the controller 4 gradually raises the rotation speed of the motor 31 from the time point t4 when the decrease of the air pressure is detected by the pressure detector 3. Thereby, the controller 4 can keep the jet height H of the molten solder 11 at the ideal value, and can also keep the air pressure at the reference value.

Thereafter, when the molten solder 11 is refilled into the jet-flow soldering device 10 at a time point t5, for example, the jet height H of the molten solder 11 gradually increases from the time point t5 as illustrated with a dashed line of FIG. 4 in a state where the rotation speed of the motor 31 is kept constant. At this time, the air pressure gradually increases in accordance with the increase of the jet height H of the molten solder 11.

Therefore, the controller 4 gradually reduces the rotation speed of the motor 31 from the time point t5 when the increase of the air pressure is detected by the pressure detector 3. Thereby, the controller 4 can keep the jet height H of the molten solder 11 at the ideal value, and can also keep the air pressure at the reference value.

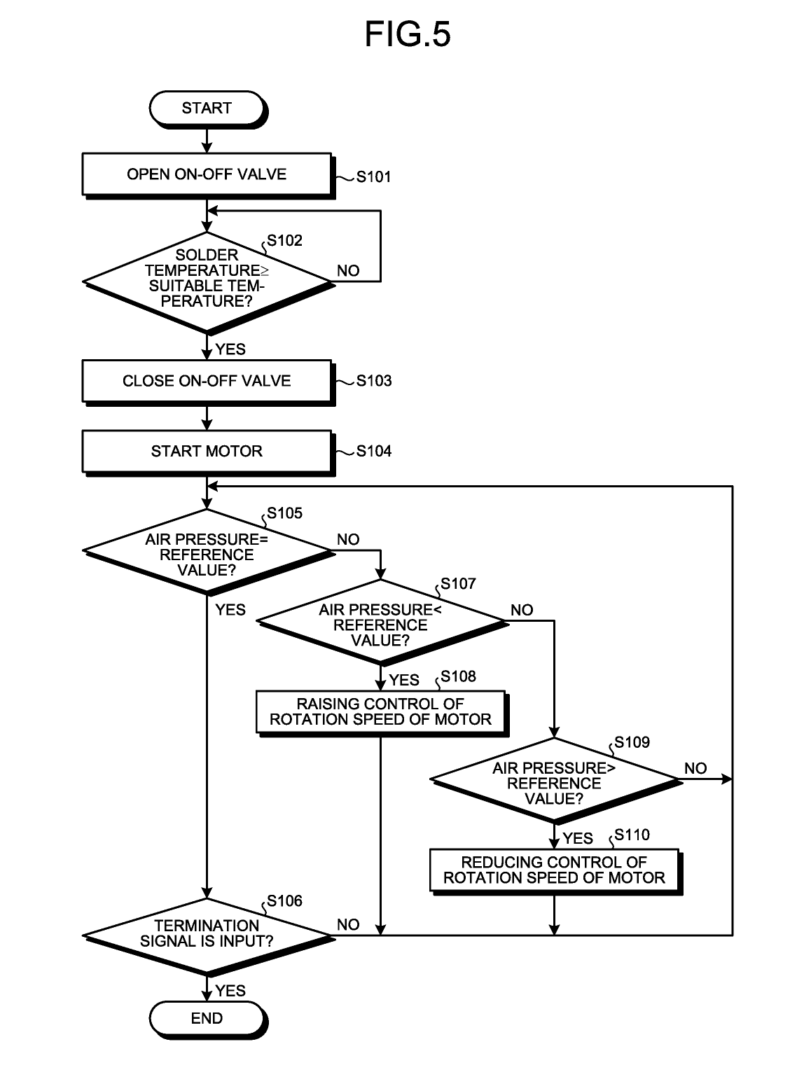

Next, a process that is executed by the controller 4 according to the embodiment will be explained with reference to FIG. 5. FIG. 5 is a flowchart illustrating a process that is executed by the controller 4 according to the embodiment. The controller 4 performs the process illustrated in FIG. 5 when the jet-flow soldering device 10 is started.

Specifically, as illustrated in FIG. 5, the controller 4 first opens the on-off valve 7 (step S101), and determines whether or not a solder temperature is equal to or larger than the suitable temperature (step S102). When determining that the solder temperature is not equal to or larger than the suitable temperature (step S102: No), the controller 4 repeats the determination process of step S102 until the solder temperature is equal to or larger than the suitable temperature.

when determining that the solder temperature becomes equal to or larger than the suitable temperature (step S102: Yes), the controller 4 closes the on-off valve 7 (step S103) and starts the motor 31 (step S104).

Then, the controller 4 determines whether or not an air pressure is equal to the reference value (step S105). When determining that the air pressure is not equal to the reference value (step S105: No), the controller 4 determines whether or not the air pressure is smaller than the reference value (step S107).

When determining that the air pressure is smaller than the reference value (step S107: Yes), the controller 4 performs control for raising the rotation speed of the motor 31 (step S108) and moves the process to step S105.

When determining that the air pressure is not smaller than the reference value (step S107: No), the controller 4 determines whether or not the air pressure is larger than the reference value (step S109). When determining that the air pressure is larger than the reference value (step S109: Yes), the controller 4 performs control for reducing the rotation speed of the motor 31 (step S110) and moves the process to step S105.

When determining that the air pressure is not larger than the reference value (step S109: No), the controller 4 moves the process to step S105. On the other hand, when determining that the air pressure is equal to the reference value (step S105: Yes), the controller 4 determines whether or not a termination signal is input (step S106).

The termination signal is input into the controller 4 from the receiver 6 when a user performs a termination operation for terminating a forced-feed pressure control process with respect to the receiver 6, for example. When determining that the termination signal is not input (step S106: No), the controller 4 moves the process to step S105. On the other hand, the controller 4 terminates the process when determining that the termination signal is input (step S106: Yes).

As mentioned above, the forced-feed pressure control device according to the embodiment includes the pressure detection nozzle, the pressure detector, and the controller. One end of the pressure detection nozzle is inserted into a casing member from which molten solder is forcibly fed to a solder jet nozzle of a jet-flow soldering device.

The pressure detector is connected to the other end of the pressure detection nozzle to detect a pressure of molten solder forcibly input from the one end into the pressure detection nozzle by using gas that exists between the molten solder inside the pressure detection nozzle and the pressure detector.

The controller adjust the forced-feed pressure of the molten solder to the solder jet nozzle so that the pressure of the molten solder to be detected by the pressure detector becomes a reference pressure. Thereby, the forced-feed pressure control device can control the jet height of the molten solder to the ideal height.

In the aforementioned embodiment, the pressure detector detects the air pressure in the pressure detection nozzle, however, the pressure detector may have a configuration that detects an air pressure in the pressure detection nozzle into which low oxidizing gas (for example, nitrogen gas) is inserted.

In this configuration, the on-off valve is connected to a nitrogen gas container, the on-off valve is opened until the temperature of the molten solder becomes the suitable temperature, the pressure detection nozzle is caused to communicate with the nitrogen gas container, and a pressure of the nitrogen gas in the pressure detection nozzle is equalized to the outside air pressure. Then, the on-off valve is opened after the temperature of the molten solder becomes the suitable temperature, and then the pressure of the nitrogen gas in the pressure detection nozzle is detected by the pressure detector.

Thereby, oxidization of the molten solder forcibly input into the pressure detection nozzle can be prevented. Therefore, the forced-feed pressure control device can prevent the decrease of pressure detection accuracy caused by attaching the molten solder solidified by oxidization into the pressure detection nozzle.

Moreover, in the aforementioned embodiment, the jet-flow soldering device jets the molten solder by using the impeller, however, the forced-feed pressure control device according to the embodiment can be applied to a soldering device that forcibly feeds nitrogen gas to jet the molten solder.

In this case, the forced-feed pressure control device can control a rotation speed of the pump that forcibly feeds nitrogen gas to the solder tank on the basis of an air pressure in the pressure detection nozzle so as to keep the jet height of the molten solder at the ideal height.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A forced-feed pressure control device comprising:
a pressure detection nozzle, one end of which is inserted into a casing member from which molten solder is forcibly fed to a solder jet nozzle of a jet-flow soldering device;
a pressure detector that is connected to another end of the pressure detection nozzle, the pressure detector detecting a pressure of molten solder forcibly input from the one end into the pressure detection nozzle by using gas that exists between the molten solder inside the pressure detection nozzle and the pressure detector; and
a controller that adjusts a forced-feed pressure of the molten solder to the solder jet nozzle so that the pressure of the molten solder to be detected by the pressure detector becomes a reference pressure.

2. The forced-feed pressure control device according to claim 1, further comprising:
a receiver that receives a height of the molten solder to be jetted from the solder jet nozzle, wherein
the controller sets, as the reference pressure, a forced-feed pressure by which the height of the molten solder to be jetted from the solder jet nozzle becomes the height received from the receiver.

3. The forced-feed pressure control device according to claim 1, wherein the controller controls a rotation speed of a pump, which forcibly feeds the molten solder to the solder jet nozzle, to adjust the forced-feed pressure.

4. The forced-feed pressure control device according to claim 2, wherein the controller controls a rotation speed of a pump, which forcibly feeds the molten solder to the solder jet nozzle, to adjust the forced-feed pressure.

5. The forced-feed pressure control device according to claim 1, further comprising:
an on-off valve that opens and closes an exhaust hole that evacuates gas inside the pressure detection nozzle; and
a temperature detector that detects a temperature of the molten solder, wherein
the controller keeps the on-off valve in an opened state until the temperature detected by the temperature detector reaches a predetermined temperature, closes the on-off valve when the detected temperature reaches the predetermined temperature, and then starts to adjust the forced-feed pressure.

6. The forced-feed pressure control device according to claim 2, further comprising:
an on-off valve that opens and closes an exhaust hole that evacuates gas inside the pressure detection nozzle; and
a temperature detector that detects a temperature of the molten solder, wherein
the controller keeps the on-off valve in an opened state until the temperature detected by the temperature detector reaches a predetermined temperature, closes the on-off valve when the detected temperature reaches the predetermined temperature, and then starts to adjust the forced-feed pressure.

7. The forced-feed pressure control device according to claim 3, further comprising:
an on-off valve that opens and closes an exhaust hole that evacuates gas inside the pressure detection nozzle; and
a temperature detector that detects a temperature of the molten solder, wherein
the controller keeps the on-off valve in an opened state until the temperature detected by the temperature detector reaches a predetermined temperature, closes the on-off valve when the detected temperature reaches the predetermined temperature, and then starts to adjust the forced-feed pressure.

8. The forced-feed pressure control device according to claim 4, further comprising:
an on-off valve that opens and closes an exhaust hole that evacuates gas inside the pressure detection nozzle; and
a temperature detector that detects a temperature of the molten solder, wherein
the controller keeps the on-off valve in an opened state until the temperature detected by the temperature detector reaches a predetermined temperature, closes the on-off valve when the detected temperature reaches the predetermined temperature, and then starts to adjust the forced-feed pressure.

9. A forced-feed pressure control method that is executed by a computer, the method comprising:
detecting, by a pressure detector, a pressure of molten solder forcibly input from one end of a pressure detection nozzle into the pressure detection nozzle by using gas that exists between the molten solder inside the pressure detection nozzle and the pressure detector, the one end of the pressure detection nozzle being inserted into a casing member from which molten solder is forcibly fed to a solder jet nozzle of a jet-flow soldering device; and
adjusting a forced-feed pressure of the molten solder to the solder jet nozzle so that the pressure of the molten solder becomes a reference pressure.
